(19) United States
(12) Patent Application Publication
(10) Pub. No.: US 2013/0060503 A1
(43) Pub. Date: Mar. 7, 2013

(54) APPARATUS FOR TESTING ELECTRONIC POWER SYSTEMS

(71) Applicant: Lance Palatini, Morris Plains, NJ (US)

(72) Inventor: Lance Palatini, Morris Plains, NJ (US)

(73) Assignee: EXPERIUM TECHNOLOGIES, LLC, Owings, MD (US)

(21) Appl. No.: 13/224,888

(22) Filed: Sep. 2, 2011

(51) Int. Cl. G06F 19/00

(52) U.S. Cl. 702/108

(57) ABSTRACT

A transistorized load system for testing electronic power systems devices includes at least one field effect transistor that is microprocessor-controlled for simulating the current drawn by a specific product on an electronic power source. The transistorized load system is capable of accepting command information either manually or from a personal computer derived source, and determining the exact value of current drawn from the electrical power system under test. The transistorized load may accept values for a desired resistance value in ohms, and/or a desired capacitance value in farads. Once voltage is applied across the positive and negative terminals of the transistorized load, the microprocessor controls the current drawn from the device under test.

### BACKGROUND OF THE INVENTION

A transistorized load system for testing electronic power systems devices includes at least one field effect transistor that is microprocessor-controlled for simulating the current drawn by a specific product on an electronic power source.

### BRIEF DESCRIPTION OF THE PRIOR ART

A microprocessor-controlled load system may be programmed to simulate a wide variety of current drawn profiles. These include current loads that remain at a fixed value (constant current) or current loads that respond proportionately to an applied voltage (constant resistance or constant power). In the constant current mode, the current drawn from the device under test remains at a fixed value (I) under all voltage values created by the device.

In a constant resistance mode, the current drawn by the transistorized load is proportional to the voltage value created by the device under test according to the formula I=V/R, where the resistance R is the programmed desired ratio of voltage to current.

In a constant power mode, the current drawn by the transistorized load is also proportional to the voltage value created by the device under test, where P is the programmed desired quotient of voltage multiplied by current.

In constant voltage mode, the current drawn by the transistorized load is automatically adjusted so as to maintain a constant voltage applied by the device under test. Many devices, particularly batteries, will experience a reduction in output voltage as increased current is drawn by the transistorized load, as well as an increase in output voltage as current drawn by the transistorized load is decreased.

The present invention was developed to provide an improved transistorized system for testing electronic power systems equipment.

### SUMMARY OF THE INVENTION

Accordingly, a primary object of the invention is to provide a transistorized load system utilizing multiple transistors connected in parallel across its positive and negative terminals, wherein the current drawn by these transistors is determined by a microprocessor controlled voltage source. The inherent capability of the microprocessor to perform simple arithmetic calculations allows the transistorized load to maintain the specified ratio or quotient of voltage and current.

In one embodiment, the transistorized load system is a microprocessor controlled device capable of determining the exact value of current drawn from the electrical power system under test. This device is capable of accepting command information either manually or from a personal computer derived source. In each case, the transistorized load may accept values for both a desired resistance value in ohms, and a desire capacitance value in farads. Once voltage is applied across the positive and negative terminals of the transistorized load, the microprocessor controls current drawn from the device under test.

### BRIEF DESCRIPTION OF THE DRAWINGS

Other objects and advantages of the invention will become apparent from a study of the following specification, when viewed in the light of the accompanying drawing, in which:

FIG. 1 is a circuit diagram of an inductance circuit;

FIG. 2 is a graph illustrating the time reaction of the circuit of FIG. 1;

FIG. 3 is a circuit diagram of a capacitance circuit;

FIG. 4 is a graph illustrating the time reaction of the circuit of FIG. 3; and

FIG. 5 is a block diagram of the test circuit of the present invention.

### DETAILED DESCRIPTION

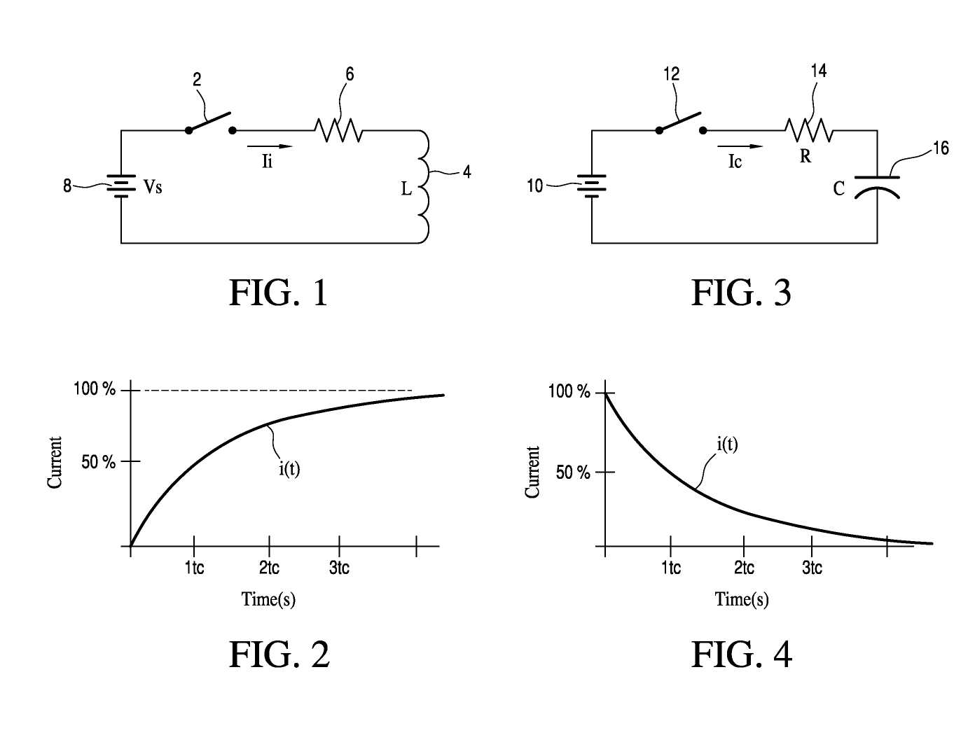

Referring first more particularly to FIG. 1, there is shown a circuit including a switch 2, and inductor 4, a resistor 6 and a voltage source 8. The inductor 4 is an electrical component capable of energy storage. Unlike the resistor 6 which simply passes current according to Ohms law, the current flowing through an inductor 4 will depend on the size of the inductor and the amount of time that has passed from closing of switch 2 and the initial application of voltage from the voltage source 8. Using the circuit of FIG. 1 as an example, once the switch 2 is closed, the current Ii through the inductor 4 starts at 0 and rises exponentially to the value:

Ii=V source/R (1)

This is shown in the graph of FIG. 2, wherein once the switch 2 is closed, the current through the inductor 4 starts at 0 and rises exponentially to V source/R, according to the formula:

$$i ( t ) = \frac{V}{R} ( 1 - {e}^{- tR \text{/} L} ) \qquad ( 2 )$$

where V is the voltage generated by the device under test across the positive and negative terminals of the transistorized device under test, R is the programmed resistance value, L is the programmed inductance value, and t is the time in seconds measured after the application of voltage across the positive and negative terminals of the transistorized load.

Because the current through the inductor can be modeled by an exponential equation, an electronic load can use its internal microprocessor to perform this calculation and thereby simulate this capacitive effect mathematically.

Similarly, a capacitor is an electronic component capable of energy storage. Unlike a resistor which simply passes current according to Ohms law, the current flowing through a capacitor will depend on the size of the capacitor and the amount of time that has passed from the initial application of voltage. Using the circuit of FIG. 3 as an example, when the switch 12 is closed, the current Ic through the capacitor 16 starts at voltage source 10 of Vs/R, and falls exponentially to 0 as shown by the graph of FIG. 4, according to the formula:

$$i ( t ) = \frac{Vo}{R} {e}^{- t \text{/} RC} \qquad ( 3 )$$

where Vo is the voltage generated by the device under test across the positive and negative terminals of the transistorized load, R is the programmed resistance value, C is the programmed capacitance value, and t is the time in seconds measured after the application of voltage across the terminals of the transistorized load.

Because the current through the capacitor can be modeled by an exponential equation, an electronic load can use the internal microprocessor to perform this calculation and thereby simulate this capacitive effect mathematically.

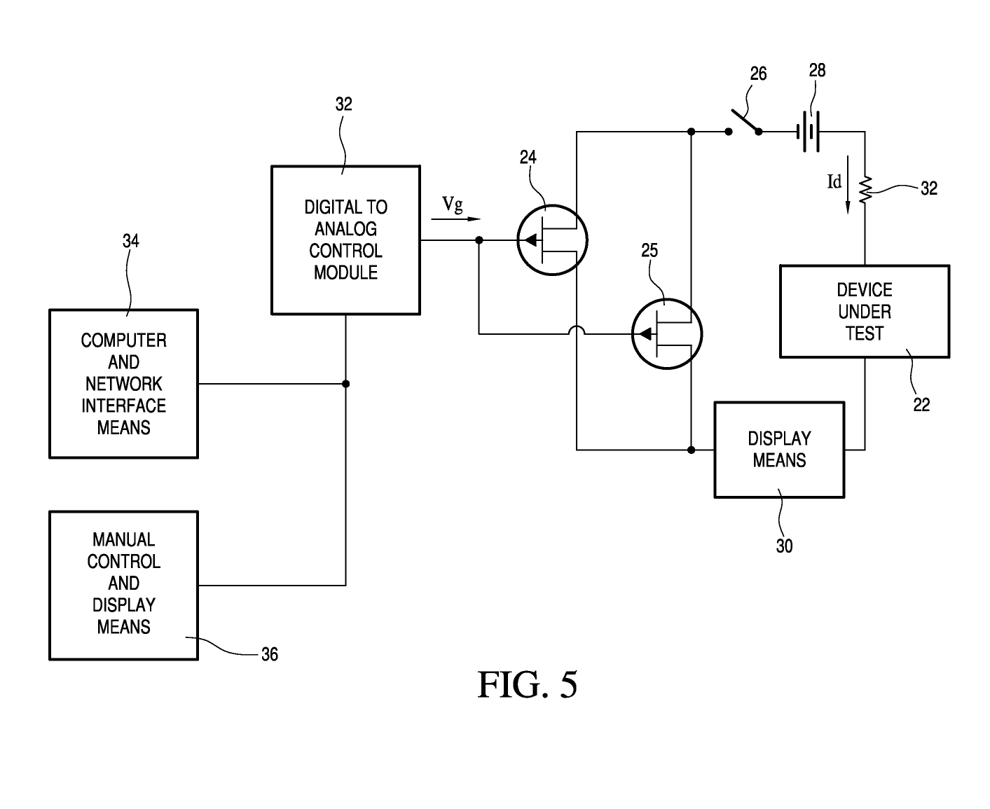

Referring now to FIG. 5, according to the present invention, a transistorized electronic load system 20 simulates the drain current Id drawn by an electronic power device under test 22, use being made of the current control capacity of a field effect transistor (FET) 24. A field effect transistor is an elemental electronic device wherein the current through the device is controlled by the gate voltage Vg applied to a specific terminal of the FET. More particularly, the drain current Id through the two power electrodes of the FET device 24 is proportional to the gate voltage Vg applied to the third terminal. Essentially the FET can be modeled by the following simple equation:

Id=Constant*Vg (4)

In an electronic load system, multiple FET devices are connected in parallel to achieve the maximum desired current. In addition, the control voltage Vg applied to the FET device is created by a digital to analog voltage converter (DAC) connected with the system microprocessor where the processor sends a binary digital pattern to the DAC (V binary) which then generates the appropriate V gate signal to the FET modeled as follows:

V gate=Constant*V binary (5)

Combining the 2 equations yields:

Id=Constant*V binary (6)

An electronic load system uses this relationship to create high currents that can be controlled in a very precise manner In the block diagram of FIG. 5, the analog control and measurement processor 32 provides the voltage gate signal Vg to the FET circuits, thereby to control to a desired value the load current Id that is supplied to the device under test 22. This desired current Id is determined by the user via either the manual control interface 36, or a computer network interface 34. Consequently, when the test switch 26 is closed, the power systems device 22 is supplied with a drain current Id, with the result that the electrical output signal of the device 22 is indicated by the indicating means 30.

According to a modification of the invention, one or more additional field effect transistors 25 may be connected in parallel across the FET 24, thereby to provide the desired drain current Id.

By way of example only, the device under test may be a battery, a fuel cell, or a DC power supply since the invention operates with any type of DC voltage generating device. The applied gate voltage depends on the type of transistor used. Generally, the voltage is in the range of 4 VDC and the resulting drain current is 6 Amps DC.

While in accordance with the provisions of the Patent Statutes the preferred forms and embodiments of the invention have been illustrated and described, it will be apparent to those skilled in the art that changes may be made without deviating from the invention described above.

What is claimed is:

1. An electronic test system for testing at least one electrical property of a power systems device, comprising:
(a) a voltage source;
(b) a current indicating device;
(c) a first field effect transistor having a pair of power circuit electrodes and a control electrode;
(d) circuit means connecting said voltage source with said current indicating device and the power circuit electrodes of said first field effect transistor, said circuit means including a switch; and
(e) digital-to-analog control and measurement processor means for transmitting to said control electrode a predetermined gate voltage.

2. An electronic test system as defined in claim 1, wherein said digital-to-analog control and measurement processor means includes a manual control and information display device.

3. An electronic test system as defined in claim 2, wherein said digital-to-analog control and measurement processor means includes a manual control and information display device.

4. An electronic test system as defined in claim 3, and further comprising at least one additional field effect transistor having a pair of power circuit electrodes connected in parallel across the power circuit terminals of said first field effect transistor, and a control electrode connected with said digital-to-analog control and measurement processor means.
